(19) United States
(12) Patent Application Publication
(10) Pub. No.: US 2006/0151066 A1
(43) Pub. Date: Jul. 13, 2006

(54) Waste exhausting device for a planing machine

(76) Inventor: Bor-Yann Chuang, Taichung (TW)

Correspondence Address: TROXELL LAW OFFICE PLLC;SUITE 1404, 5205 LEESBURG PIKE, FALLS CHURCH, VA, 22041, US

(21) Appl. No.: 11/033,289

(22) Filed: Jan. 12, 2005

(51) Int. Cl. B27C 1/00; B27G 21/00; B27G 19/00

(52) U.S. Cl. 144/252.1; 144/117.1

(57) ABSTRACT

A waste exhausting device for a planing machine includes a blower assembled above the knife shaft of the planing table of a planing machine. The knife shaft has one end secured with a belt pulley, and the planing table has the sidewall of one end opposite to the belt pulley fixed with a first gear that is engaged with both an idle gear and a second gear. The second gear is coaxially connected with a turbine blade installed in the blower. The blower can be indirectly actuated to operate and carry out exhausting of wood waste by the knife shaft and via the mutually engaged first gear, second gear and idle gear. The knife shaft and the blower are driven to operate by a same motor, convenient in operating and able to save the cost of the machine.

### BACKGROUND OF THE INVENTION

1. Field of the Invention

This invention relates to a waste exhausting device for a planing machine, particularly to one having the blowing device and the knife shaft of a planing machine started to operate or stopped synchronously by a same motor, simple in its structure and saving the cost of the machine.

2. Description of the Prior Art

In the course of planing of wood materials, a conventional planing machine always produces lots of wood waste that may float about in the air or drop down on the ground to soil a work site and affect workers' health. To improve such a condition, a motor blower is additionally installed on the planing table of a planing machine for exhausting and collecting wood waste produced during planing of wood materials so as to keep a work site clean and ensure workers' health.

However, the conventional planing machine is already provided with a motor on its planing table for driving a knife shaft to operate; therefore, the motor blower additionally installed on the planing table of the planing machine not only increases the cost of the machine, but also complicates its structure and assembly and wastes some power.

### SUMMARY OF THE INVENTION

The objective of the invention is to offer a waste exhausting device for a planing machine, provided with a blower above the knife shaft of the planing table of a planing machine. The knife shaft has one end secured with a belt pulley and the planing table has the outer wall of one end opposite to the belt pulley fixed with a first gear engaged with an idle gear and a second gear. The second gear is coaxially connected with a turbine blade installed in the interior of the blower. The blower can be indirectly driven to operate and carry out exhausting of wood waste by the knife shaft and through the mutually engaged first gear, second gear and idle gear, simple in structure. The blower can be actuated to operate and stop operating synchronously together with the knife shaft, achieving effect of exhausting and stopping exhausting of wood waste automatically. The knife shaft and the blower are driven to operate by a same motor, lowering the cost of the machine.

### BRIEF DESCRIPTION OF DRAWINGS

This invention will be better understood by referring to the accompanying drawings, wherein:

FIG. 1 is a partial perspective view of a planing machine with a waste exhausting device in the present invention:

FIG. 2 is a partial exploded perspective view of the planing machine in the present invention:

FIG. 3 is an exploded perspective view of a blowing device in the present invention:

FIG. 4 is a side cross-sectional view of the structure of transmission gears and their power transmitting conditions in the present invention: and

FIG. 5 is cross-sectional view of the planing machine in a condition of wood waste exhausting in the present invention.

### DETAILED DESCRIPTION OF THE PREFERRED EMBODIMENT

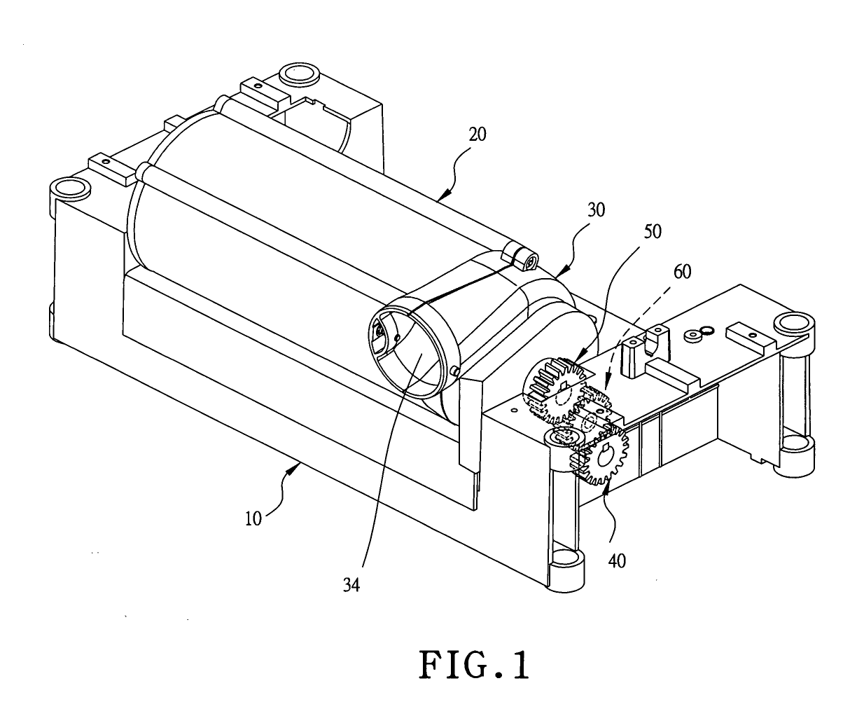

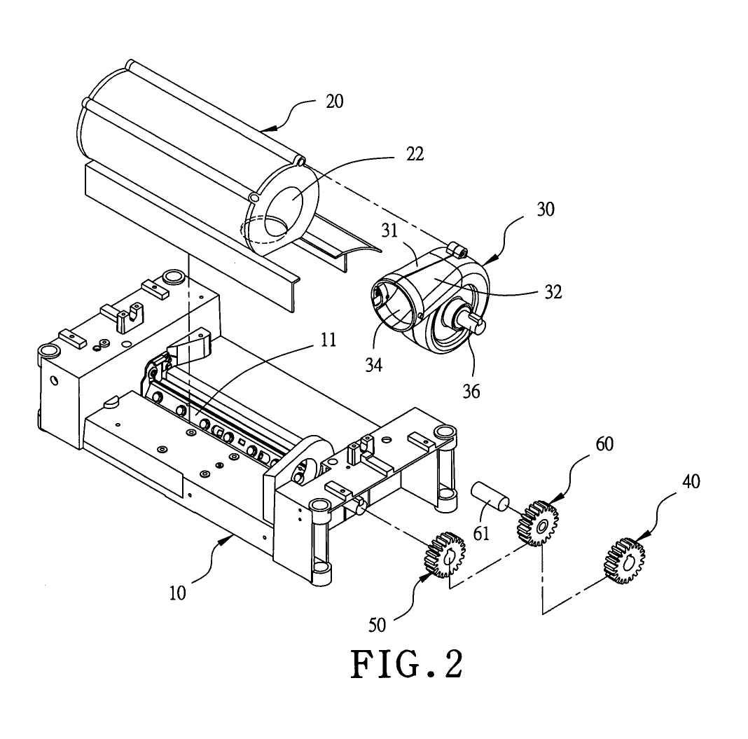

A preferred embodiment of a wood waste exhausting device for a planing machine in the present invention, as shown in FIGS. 1, 2 and 5, includes a planing table 10, a wind cover 20, a blower 30, a first gear 40, a second gear 50 and an idle gear 60 combined together.

The planing table 10 is provided thereon with a knife shaft 11 having one end secured with a belt pulley 12 driven to rotate by a motor (not shown). The planing table 10 further has the outer wall of one end opposite to the belt pulley 12 bored with a wall hole 13.

The wind cover 20 is assembled at a preset location over the knife shaft 11 of the planing table 10, with a wind chamber 21 formed between the wind cover 20 and the planing table 10. The wind cover 20 has one side formed with a wind hole 22 communicating with the wind chamber 21.

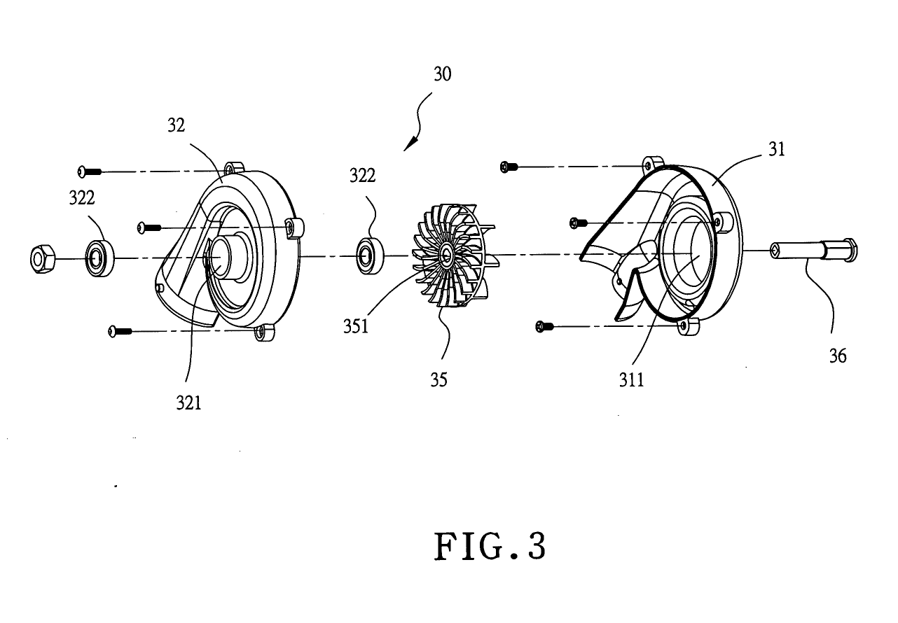

The blowing device 30, as shown in FIG. 3, includes an inner half shell 31 and an outer half shell 32 correspondingly combined together to form an interior space 33 and a wind-exhausting vent 34. The inner shell 31 has its sidewall bored with a wind inlet 311 communicating with the interior space 33, and the outer half shell 32 has a center of a sidewall formed with a through insert hole 321. The inner half shell 31 is firmly combined with the wind cover 20, letting the wind inlet 311 of the inner shell 31 communicate with the wind hole 22 of the wind cover 20. In addition, a turbine blade 35 is installed in the interior space 33 of the inner and the outer half shell 31, 32, having a central shaft hole 351 inserted there through with a rotating shaft 36. The rotating shaft 36 has one end orderly inserted through the central insert hole 321 of the outer half shell 32 and the wall hole 16 in the outer wall of the planing table 10 and fitted through plural bearings 322 positioned in the insert hole 321 of the outer shell 32.

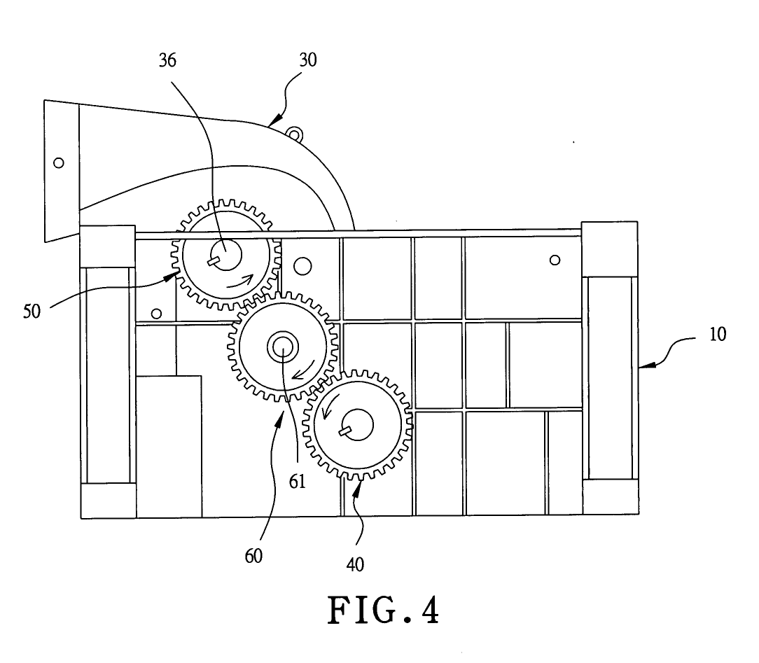

The first gear 40, as shown in FIG. 4, is secured on the knife shaft 11 at one end opposite to the belt pulley 12 to be actuated to rotate by the knife shaft 11.

The second gear 50 is fixed with the rotating shaft 36 of the blower 30, which extends out of the sidewall of the planing table 10. The second gear 50 is driven to rotate the turbine blade 35 in the blower 30.

The idle gear 60 has a spindle 61 inserted through the center and fixed with the outer sidewall of one end of the planing table 10, opposite to the belt pulley 12 of the knife shaft 11. The idle gear 60 is engaged both with the first and the second gear 40, 50 for transmitting rotating power.

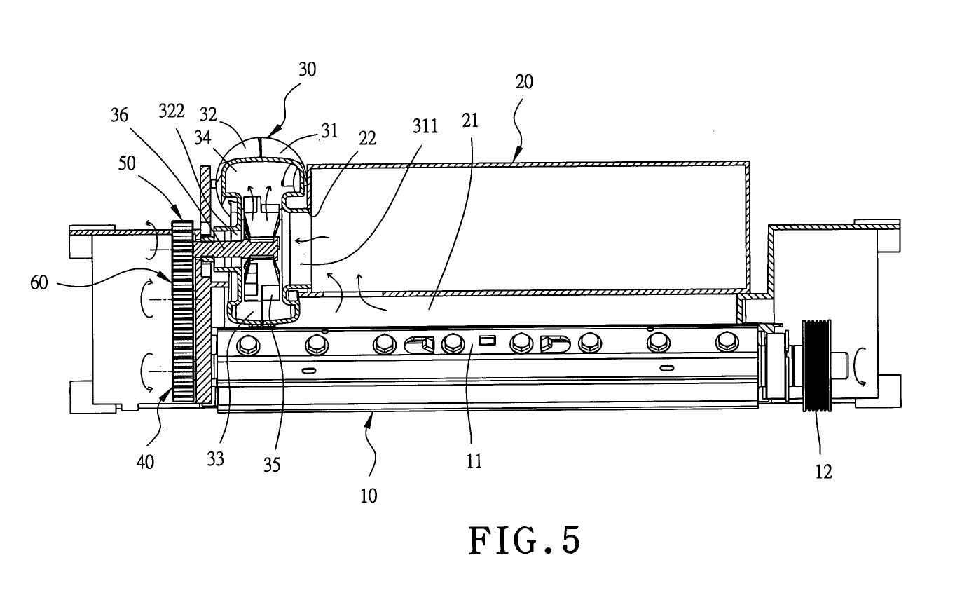

In operating, as shown in FIGS. 4 and 5, when the motor (not shown) of the planing machine is started, the power generated by the motor will be transmitted to the belt pulley 12 at one end of the knife shaft 11 by a belt to rotate the knife shaft 11 to carry out planing of wood materials. At this time, the first gear 40 at the other end of the knife shaft 11 will be synchronously actuated to rotate and transmit the power to the second gear 50 through the mutually engaged idle gear 60. Simultaneously, the second gear 50 is rotated to actuate the rotating shaft 36 of the turbine blade 35 in the blower 30 to rotate. Since the turbine blade 35 is located in the interior space 33 defined by the inner and the outer half shell 31, 32; therefore, when the turbine blade 35 rotates, there will produce a vacuum suction force at the wind inlet 311 of the inner shell 31 to suck wood waste produced during wood planing into the interior space 33 through the wind hole 22 of the wind cover 20 and the wind inlet 311 of the inner half shell 31. Then, the wood waste will be exhausted out through the wind vent 34 of the inner and the outer half shell 31, 32 and through a wind pipe (not shown) to be collected.

As can be understood from the above description, the blower 30 of this invention can be actuated to operate by the same motor that provides the knife shaft 11 with rotating power and through the mutually engaged first gear 40, second gear 50 and idle gear 60. Therefore, when the knife shaft 11 is driven to carry out planing of wood materials, the blower 30 will be synchronously started to operate together with the knife shaft 11, needless to be controlled to operate by a switch. In other words, when the knife shaft 11 is rotated to carry out planing of wood materials, the blower 30 will automatically function to perform exhausting of wood waste at the same time, and when the knife shaft 11 stops wood planing work, the blower 30 will also automatically stop functioning, quite convenient in operating. Additionally, the blower 30 and the knife shaft 11 are driven to operate by the same motor, able to simplify the structure of the planing table 10, lower the cost of the machine and obtain economic gain.

While the preferred embodiment of the invention has been described above, it will be recognized and understood that various modifications may be made therein and the appended claims are intended to cover all such modifications that may fall within the spirit and scope of the invention.

I claim:

1. A waste exhausting device for a planing machine comprising a planing table, said planing table provided thereon with a knife shaft, said knife shaft having one end secured with a belt pulley, said belt pulley driven to rotate by a motor: and characterized by,
A blower assembled at a preset location above said knife shaft of said planing table:
A first gear fixed on the other end of said knife shaft at one side of said planing table, said first gear actuated to rotate by said knife shaft:
A second gear fixed at one side of said planing table, said second gear coaxially connected with a turbine blade in said blower, said second gear rotated to actuate said turbine blade to rotate: and
An idle gear provided at a proper location of the sidewall of said planing table, said idle gear engaged both with said first gear and said second gear for transmitting rotating power, said blower actuated to operate and carry out exhausting of wood waste by said knife shaft and through said first gear, said second gear and said idle gear, said blower and said knife shaft driven to operate by a same motor.

2. The waste exhausting device for a planing machine as claimed in claim 1, wherein a wind cover is assembled at a preset location above said knife shaft of said plaing table, and a wind chamber is formed between said wind-exhausting shade and said planing table, said wind cover having one side formed with a wind hole, said wind hole communicating with said wind chamber, said blower assembled at the location of said wind hole of said wind cover, said blower able to exhaust wood waste out of said wind chamber.

3. The waste exhausting device for a planing machine as claimed in claim 2, wherein said blower has an inner half shell and an outer half shell correspondingly combined together to form an interior space and a wind hole, said inner half shell having its sidewall bored with a wind inlet communicating with said interior space, said outer half shell having its sidewall bored with an insert hole, said inner half shell connected with said wind cover, said wind inlet of said inner half shell and said wind hole of said wind cover communicating with each other, said turbine blade installed in said interior space of said inner and said half outer shell, said turbine blade bored with a shaft hole in the center, said shaft hole having a rotating shaft inserted therethrough, said rotating shaft having one end inserted through said central insert hole of said outer shell and secured with said second gear.
